(19) United States
(12) Patent Application Publication
(10) Pub. No.: US 2020/0295920 A1
(43) Pub. Date: Sep. 17, 2020

(54) DEVICE AND METHOD FOR HARDWARE-BASED DATA ENCRYPTION WITH COMPLEMENTARY RESISTIVE SWITCHES

(71) Applicant: Fraunhofer-Gesellschaft zur Foerderung der angerwandten Forschung e.V., Munich (DE)

(72) Inventors: Nan DU, Chemnitz (DE); Heidemarie SCHMIDT, Chemnitz (DE); Ramona ECKE, Chemnitz (DE); Stefan SCHULZ, Chemnitz (DE)

(21) Appl. No.: 16/809,232

(22) Filed: Mar. 4, 2020

(30) Foreign Application Priority Data
Mar. 11, 2019 (DE) 102019203288.5

(51) Int. Cl. H04L 9/06; H03K 19/21; G11C 13/00

(52) U.S. Cl. CPC H04L 9/0656; H03K 19/21; G11C 13/004; G11C 2013/0078; G11C 2213/15; G11C 2013/0045; G11C 13/0069

(57) ABSTRACT

An encoder for encoding an input binary value of a binary input data sequence by generating an output current of an output current signal is provided. The encoder includes a control module and a switchable resistive element. The switchable resistive element is configured to either be in a first state or in a different second state depending on a first input voltage at a first point in time and depending on a second input voltage at a later second point in time.

The control module is configured to apply the first input voltage to the switchable resistive element at the first point in time so that the first input voltage depends on the input binary value.

### CROSS-REFERENCE TO RELATED APPLICATION

This application claims priority from German Patent Application No. DE 10 2019 203 288.5, which was filed on Mar. 11, 2019, and is incorporated herein in its entirety by reference.

### BACKGROUND OF THE INVENTION

The application concerns hardware-based encryption of data with an electronic circuit, and, in particular, a device and a method for hardware-based data encryption with complimentary resistive switches. Furthermore, the application concerns the structure of the electronic circuit and a method for encrypting the data.

In an increasingly digitalized and connected world, the selective use of modern information and communication technologies is the decisive key to economic success. Rapidly growing data volumes (2018: 1.6 zettabytes (1.6·10²¹ bytes) [1]) have to be encrypted for a secure data infrastructure.

Digital data encryptions, also known as software-based encryption technologies, offer a good approach to protecting data. Software-based encryption has been the standard solution for data encryption up to now. Currently, individual files or folders or even the entire hard disc (in the context of a full disc encryption) can be encrypted with the help of software programs. For this purpose, a large number of software solutions from various providers is already available on the market. However, a considerable time and computing effort and the associated increased energy consumption are disadvantages of software-based full disc encryption. A software-based method will no longer be practicable in the future, given the expected rapidly growing amounts of data having to be processed.

Hardware-based encryption solves problems of the software-based encryption and enables the use of novel encryption concepts and protocols.

In hardware-based cryptography, the data or exchanged signals are encrypted through the hardware components (encryption hardware) directly on the data carrier in real time without the use of additional software, thus protecting it/them from unwanted insights. If the storage medium is physically lost, the stored data is still secure. In real-time operation, the use of hardware cryptography additionally allows for longer key lengths than previously possible. Hardware encryption therefore offers considerable security advantages and at the same time reduces the system load, since encryption involves no processor power.

A known solution for storing keys for cryptographic applications is the so-called physical unclonable function (PUF).

Like a fingerprint, the PUF is an individual property that is bound to a physical object (encryption hardware). Today, PUFs are used for identifying components of integrated circuits or as a replacement for storing keys for cryptographic applications. The challenge in realizing a PUF is to find a physical object (encryption hardware) that has an unpredictable individual property.

Due to the stochastic behavior of memristors, memristors are ideal potential candidates for the realization of encryption hardware. Memristors are novel microelectronic components whose electrical resistance can be specifically adjusted depending on the current flow and then remains non-volatile without an external voltage being applied—hence the artificial word consisting of memory and resistor. It is suspected that memristors are not susceptible to noise and environmental influences due to their non-volatile behavior. At the same time, however, the individual properties of memristors depend heavily and uncontrollably on the manufacturing process and are therefore unpredictable.

For example, memristors were described in [6].

Various different protocols have already been developed for PUFs in different applications. For example, the BiFeO₃ (BFO) platform (BFO/ BiFeO₃=bismuth-iron oxide) opens up the possibility of using the BFO platform as a PUF in the hardware-based cryptography due to the memristive properties of BFO. For example, a protocol describes how the non-volatile non-linear resistance change of BFO memristors will be used for the generation of higher harmonics which can be used to easily encrypt and decrypt digital data sets [2], [3]. These higher harmonics can be transmitted to the receiver in a wireless manner and can be decoded by the receiver using hardware-based cryptography. The minimization of the autocorrelation of these higher harmonics has been fundamentally shown using BFO-based cryptography [3].

The transmitted data set can only be decoded if the identical BFO memristor and the identical random number generator as well as the identical cryptography circuit used by the transmitter for decrypting the data are available. It was also shown how the BFO-based memristor can be used for protecting personal data in the field of medicine [4].

The protocol's property of the transmitted data set only being decoded if the identical BOF memristor and the identical random number generator as well as the identical cryptography circuit used by the transmitter for decrypting the data are available represents a security gap. So far, this security gap could not be closed.

In 2014, a BiFeO₃ memristor having two reconfigurable barriers was realized [5], [2] and a method for realizing a reconfigurable logic on the basis of a BiFeO₃ memristor having two reconfigurable barriers was shown [5], [2].

SUMMARY

According to an embodiment, an encoder for encoding an input binary value of a binary input data sequence by generating an output current of an output current signal may have: a control module; and a switchable resistive element configured to either be in a first state or in a different second state depending on a first input voltage at a first point in time and depending on a second input voltage at a later second point in time, wherein the control module is configured to apply the first input voltage to the switchable resistive element at the first point in time so that the first input voltage depends on said input binary value, wherein the control module is configured to apply the second input voltage to the switchable resistive element at the second point in time so that the second input voltage depends on a pseudo-random binary value of a plurality of pseudo-random binary values of a first binary pseudo-random data sequence, wherein the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence, and wherein switchable resistive element is configured, upon applying the third input voltage at the third point in time, to output said output current so that said output current depends on the third input voltage and depends on whether the switchable resistive element is in the first state or in the second state.

According to another embodiment, a decoder for decoding an input current of an input current signal by outputting an output binary value of a binary output data sequence may have: a control module, a switchable resistive element configured to either be in a first state or in a different second state depending on a first input voltage at a first point in time and depending on a second input voltage at a later second point in time, and a comparator, wherein control module is configured to apply the first input voltage to the switchable resistive element at the first point in time so that the first input voltage depends on a sample binary value of a plurality of sample binary values, the control module is configured to apply the second input voltage to the switchable resistive element at the second point in time so that the second input voltage depends on a pseudo-random binary value of a plurality of pseudo-random binary values of a first binary pseudo-random data sequence, wherein the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence, and wherein the switchable resistive element is configured, upon applying the third input voltage at the third point in time, to provide an output current to the comparator so that said output current depends on the third input voltage and depends on whether the switchable resistive element is in the first state or in the second state, wherein comparator is configured to perform a comparison between said output current and said input current, wherein the comparator is configured, depending on the comparison and said sample binary value, to determine said output binary value, and wherein the comparator is configured to output said output binary value.

According to another embodiment, a system may have: an inventive encoder for encoding an input binary value of a binary input data sequence by generating an output current of an output current signal, and an inventive decoder for decoding an input current of an input current signal by outputting an output binary value of a binary output data sequence, wherein the inventive decoder is configured to use the output current generated by the inventive encoder as an input current and decode the same.

Another embodiment may have a method for encoding an input binary value of a binary input data sequence by generating an output current of an output current signal, wherein a switchable resistive element is configured to either be in a first state or in a different second state depending on a first input voltage at a first point in time and depending on a second input voltage at a later second point in time, the method having the steps of: applying the first input voltage to the switchable resistive element at the first point in time so that the first input voltage depends on said input binary value; applying the second input voltage to the switchable resistive element at the second point in time so that the second input voltage depends on a pseudo-random binary value of a plurality of pseudo-random binary values of a first binary pseudo-random data sequence; applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; and upon applying the third input voltage at the third point in time, outputting said output current by the switchable resistive element so that said output current depends on the third input voltage and depends on whether the switchable resistive element is in the first state or in the second state.

Another embodiment may have a method for decoding an input current of an input current signal by outputting an output binary value of a binary output data sequence, wherein a switchable resistive element is configured to either be in a first state or in a different second state depending on a first input voltage at a first point in time and depending on a second input voltage at a later second point in time, the method having the steps of: applying the first input voltage to the switchable resistive element at the first point in time so that the first input voltage depends on a sample binary value of a plurality of sample binary values; applying the second input voltage to the switchable resistive element at the second point in time so that the second input voltage depends on a pseudo-random binary value of the plurality of pseudo-random binary values of a first binary pseudo-random data sequence; applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; upon applying the third input voltage at the third point in time, providing an output current by the switchable resistive element so that said output current depends on the third input voltage and depends on whether the switchable resistive element is in the first state or in the second state, and performing a comparison between said output current and said input current, determining said output binary value depending on the comparison and on said sample binary value, and outputting said output binary value.

Another embodiment may have a non-transitory digital storage medium having a computer program stored thereon to perform the method for encoding an input binary value of a binary input data sequence by generating an output current of an output current signal, wherein a switchable resistive element is configured to either be in a first state or in a different second state depending on a first input voltage at a first point in time and depending on a second input voltage at a later second point in time, the method having the steps of: applying the first input voltage to the switchable resistive element at the first point in time so that the first input voltage depends on said input binary value; applying the second input voltage to the switchable resistive element at the second point in time so that the second input voltage depends on a pseudo-random binary value of a plurality of pseudo-random binary values of a first binary pseudo-random data sequence; applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; and upon applying the third input voltage at the third point in time, outputting said output current by the switchable resistive element so that said output current depends on the third input voltage and depends on whether the switchable resistive element is in the first state or in the second state, when said computer program is run by a computer.

Another embodiment may have a non-transitory digital storage medium having a computer program stored thereon to perform the method for decoding an input current of an input current signal by outputting an output binary value of a binary output data sequence, wherein a switchable resistive element is configured to either be in a first state or in a different second state depending on a first input voltage at a first point in time and depending on a second input voltage at a later second point in time, the method having the steps of: applying the first input voltage to the switchable resistive element at the first point in time so that the first input voltage depends on a sample binary value of a plurality of sample binary values; applying the second input voltage to the switchable resistive element at the second point in time so that the second input voltage depends on a pseudo-random binary value of the plurality of pseudo-random binary values of a first binary pseudo-random data sequence; applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; upon applying the third input voltage at the third point in time, providing an output current by the switchable resistive element so that said output current depends on the third input voltage and depends on whether the switchable resistive element is in the first state or in the second state, and performing a comparison between said output current and said input current, determining said output binary value depending on the comparison and on said sample binary value, and outputting said output binary value, when said computer program is run by a computer.

An encoder for encoding an input binary value of a binary input data sequence by generating an output current of an output current signal is provided. The encoder includes a control module and a switchable resistive element. The switchable resistive element is configured to either be in a first state or in a different second state depending on a first input voltage at a first point in time and depending on a second input voltage at a later second point in time. The control module is configured to apply the first input voltage to the switchable resistive element at the first point in time so that the first input voltage depends on said input binary value. In addition, the control module is configured to apply the second input voltage to the switchable resistive element at the second point in time so that the second input voltage depends on a pseudo-random binary value of a plurality of pseudo-random binary values of a first binary pseudo-random data sequence. In addition, the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence. The switchable resistive element is configured, upon applying the third input voltage at the third point in time, to output said output current so that said output current depends on the third input voltage and depends on whether the switchable resistive element is in the first state or in the second state.

In addition, a decoder for decoding an input current of an input current signal by outputting an output binary value of a binary output data sequence is provided. The decoder includes a control module, a switchable resistive element and a comparator. The switchable resistive element is configured to either be in a first state or in a different second state depending on a first input voltage at a first point in time and depending on a second input voltage at a later second point in time. The control module is configured to apply the first input voltage to the switchable resistive element at the first point in time so that the first input voltage depends on a sample binary value of a plurality of sample binary values. In addition, the control module is configured to apply the second input voltage to the switchable resistive element at the second point in time so that the second input voltage depends on an pseudo-random binary value of a plurality of pseudo-random binary values of a first binary pseudo-random data sequence. In addition, the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence. The switchable resistive element is configured, upon applying the third input voltage at the third point in time, to provide an output current to the comparator so that said output current depends on the third input voltage and depends on whether the switchable resistive element is in the first state or in the second state. The comparator is configured to perform a comparison between said output current and said input current, wherein the comparator is configured, depending on the comparison and said sample binary value, to determine said output binary value, and wherein the comparator is configured to output said output binary value.

In addition, a method for encoding an input binary value of a binary input data sequence by generating an output current of an output current signal is provided. A switchable resistive element is configured to either be in a first state or in a different second state depending on a first input voltage at a first point in time and depending on a second input voltage at a later second point in time. The method includes:
applying the first input voltage to the switchable resistive element at the first point in time so that the first input voltage depends on said input binary value;
applying the second input voltage to the switchable resistive element at the second point in time so that the second input voltage depends on a pseudo-random binary value of a plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; and
upon applying the third input voltage at the third point in time, outputting said output current by the switchable resistive element so that said output current depends on the third input voltage and depends on whether the switchable resistive element is in the first state or in the second state.

In addition, a method for decoding an input current of an input current signal by outputting an output binary value of a binary output data sequence is provided. A switchable resistive element is configured to either be in a first state or in a different second state depending on a first input voltage at a first point in time and depending on a second input voltage at a later second point in time. The method includes:
applying the first input voltage to the switchable resistive element at the first point in time so that the first input voltage depends on a sample binary value of a plurality of sample binary values;
applying the second input voltage to the switchable resistive element at the second point in time so that the second input voltage depends on a pseudo-random binary value of the plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence;
upon applying the third input voltage at the third point in time, providing an output current by the switchable resistive element so that said output current depends on the third input voltage and depends on whether the switchable resistive element is in the first state or in the second state; and
performing a comparison between said output current and said input current, determining said output binary value depending on the comparison and on said sample binary value, and outputting said output binary value.

In addition, computer programs each having a program code for performing one of the above-described methods are provided.

### BRIEF DESCRIPTION OF THE DRAWINGS

Embodiments of the present invention will be detailed subsequently referring to the appended drawings, in which:

FIG. 1 shows an encoder for encoding an input binary value of a binary input data sequence by generating an output current of an output current signal according to an embodiment.

FIG. 2 shows a decoder for decoding an input current of an input current signal by outputting an output binary value of a binary output data sequence according to an embodiment.

FIG. 3 shows a system according to an embodiment.

FIG. 4 shows a read current I of a complimentary resistor according to an embodiment.

FIG. 5 schematically shows a block circuit diagram for encryption and decryption of binary data using two random number generators according to an embodiment.

FIG. 6 illustrates how binary data is encrypted into three analog elements of data each using three different amplitudes according to an embodiment.

FIG. 7 schematically shows a block circuit diagram for encryption and decryption of binary data using three random number generators according to an embodiment.

### DETAILED DESCRIPTION OF THE INVENTION

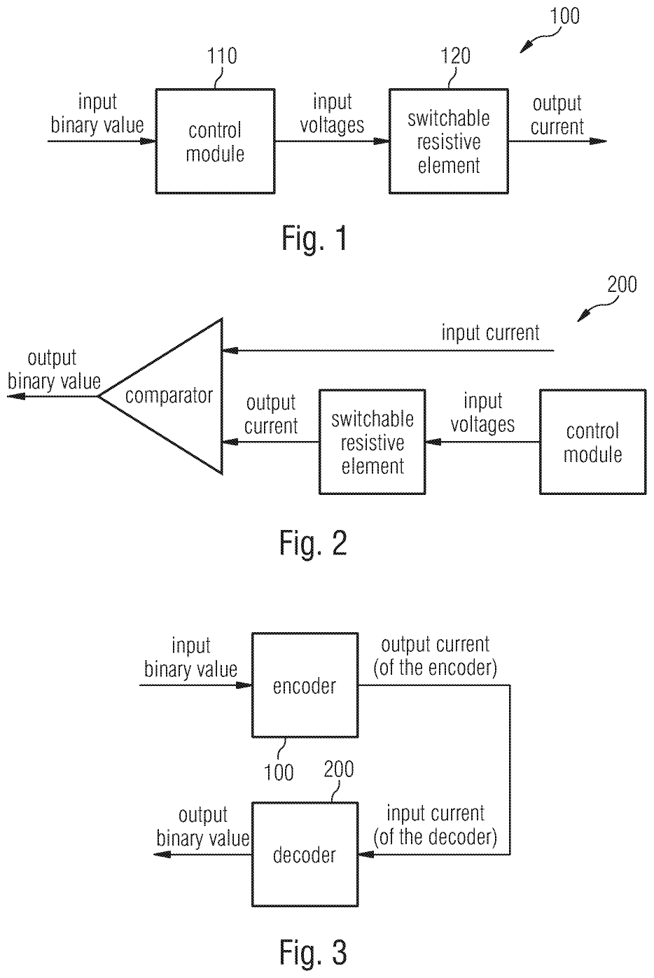

FIG. 1 shows an encoder 100 for encoding an input binary value of a binary input data sequence by generating an output current of an output current signal according to an embodiment. The encoder 100 includes a control module 110 and a switchable resistive element 120.

The switchable resistive element 120 (also referred to as complimentary resistive switch) is configured to either be in a first state or in a different second state depending on a first input voltage at a first point in time and depending on a second input voltage at a later second point in time.

The control module 110 is configured to apply the first input voltage to the switchable resistive element 120 at the first point in time so that the first input voltage depends on said input binary value.

In addition, the control module 110 is configured to apply the second input voltage to the switchable resistive element 120 at the second point in time so that the second input voltage depends on a pseudo-random binary value of a plurality of pseudo-random binary values of a first binary pseudo-random data sequence.

In addition, the control module 110 is configured to apply a third input voltage to the switchable resistive element 120 at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence.

The switchable resistive element 120 is configured, upon applying the third input voltage at the third point in time, to output said output current so that said output current depends on the third input voltage and depends on whether the switchable resistive element 120 is in the first state or in the second state.

According to an embodiment, e.g., the switchable resistive element 120 may be configured, upon applying the third input voltage at the third point in time, to output said output current such that:
said output current comprises a first output current value if the third input voltage comprises a first input voltage value and the switchable resistive element 120 is in the first state,
said output current comprises a second output current value larger than the first output current value if the third input voltage comprises a second input voltage value and the switchable resistive element 120 is in the first state,
said output current comprises a third output current value if the third input voltage comprises the first input voltage value and the switchable resistive element 120 is in the second state, and
such that said output current comprises a fourth output current value smaller than the third output current value if the third input voltage comprises the second input voltage value and the switchable resistive element 120 is in the second state.

In this case, e.g., the first output current value and the fourth output current value may be equal or different, and, e.g., the second output current value and the third output current value may be equal or different.

In an embodiment, e.g., the switchable resistive element 120 may be a memristor.

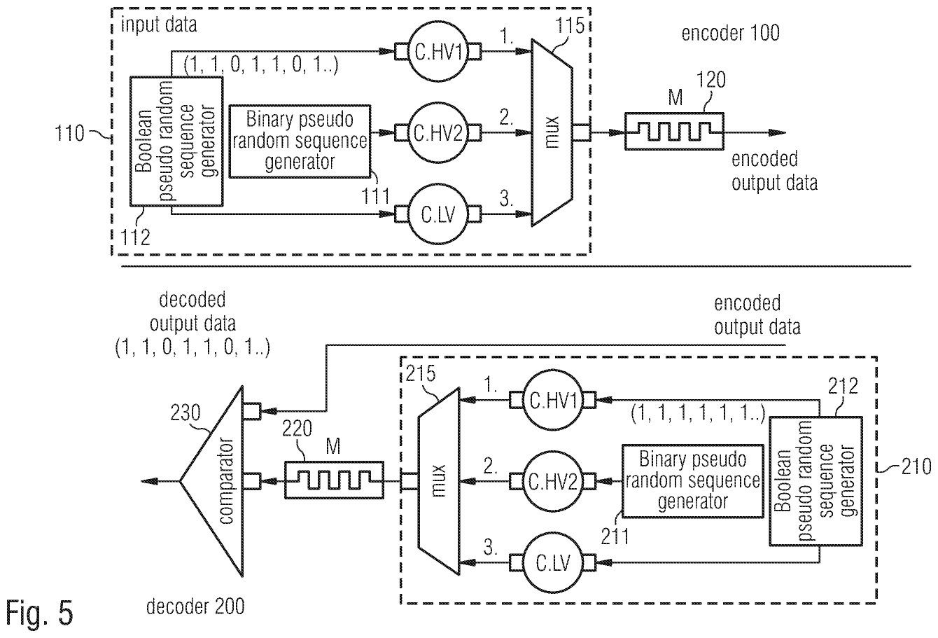

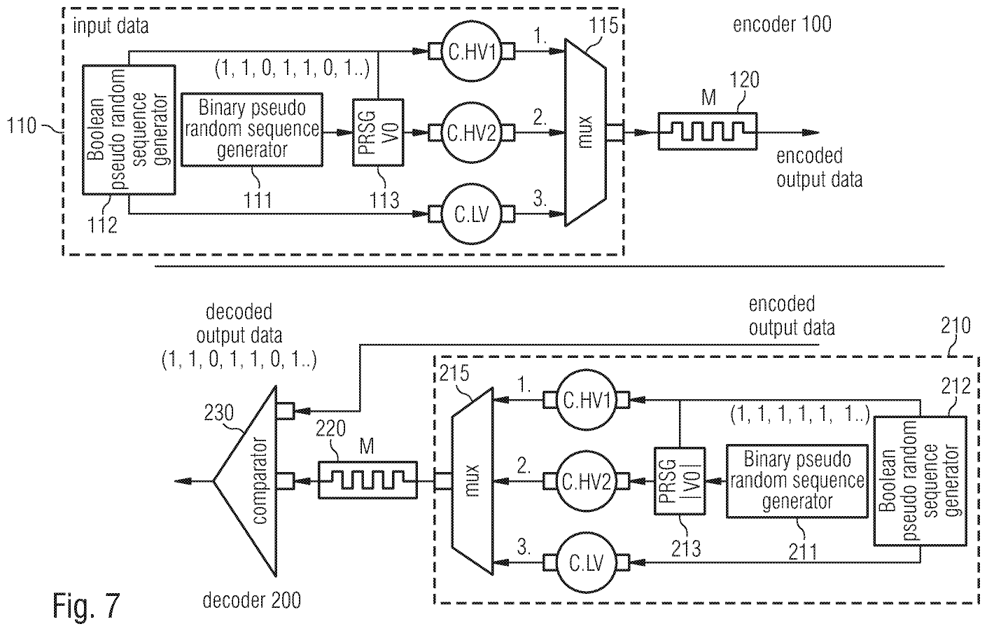

According to an embodiment, e.g., the control module 110 may comprise a first pseudo-random generator 111, e.g., that may be configured to generate the first pseudo-random generator sequence. Or, e.g., the control module 110 may include the first pseudo-random generator 111, e.g., that may be configured to generate the first pseudo-random generator sequence, and, e.g., wherein the control module 110 may include a second pseudo-random generator 112, e.g., that may be configured to generate the second pseudo-random generator sequence (cf. FIG. 5 and FIG. 7).

In an embodiment, e.g., the control module 110 may be configured to link said input binary value to said pseudo-random binary value of the plurality of pseudo-random binary values of the second binary pseudo-random data sequence by means of a Boolean operation in order to obtain a combination binary value. In this case, e.g., the control module 110 may be configured to apply the first input voltage to the switchable resistive element 120 at the first point in time so that the first input voltage depends on the combination binary value. In addition, e.g., the control module 110 may be configured to apply the third input voltage to the switchable resistive element 120 at the third point in time so that the third input voltage depends on said pseudo-random binary value of the plurality of pseudo-random binary values of the second binary pseudo-random data sequence.

According to an embodiment, e.g., the Boolean operation may be a XOR operation or a XNOR operation.

In an embodiment, e.g., the control module 110 may be configured to apply the third input voltage to the switchable resistive element 120 at the third point in time so that the third input voltage does not depend on said input binary value.

According to an embodiment, e.g., the control module 110 may be configured to apply the first input voltage to the switchable resistive element 120 so that the first input voltage is either positive or negative depending on said input binary value. In this case, e.g., the control module 110 may be configured to apply the second input voltage to the switchable resistive element 120 so that the second input voltage is either positive or negative depending on said pseudo-random binary value of the plurality of pseudo-random binary values of the first binary pseudo-random data sequence. In addition, e.g., the control module 110 may be configured to apply the third input voltage to the switchable resistive element 120 so that the third input voltage is either positive or negative depending on said pseudo-random binary value of the plurality of pseudo-random binary values of the first binary pseudo-random data sequence or depending on said pseudo-random binary value of the plurality of pseudo-random binary values of the second binary pseudo-random data sequence.

In an embodiment, e.g., the control module 110 may be configured to determine an amplitude of the first input value and/or of the second input value depending on a pseudo-random value of a third pseudo-random data sequence.

According to an embodiment, e.g., the control module 110 may be configured to determine one of three or more different amplitude values for the amplitude of the first input voltage and/or of the second input voltage depending on said pseudo-random value of the third pseudo-random data sequence.

In an embodiment, e.g., the control module 110 may include a third pseudo-random generator 113, e.g., that may be configured to generate the third pseudo-random generator sequence so that each pseudo-random value of the third pseudo-random data sequence adopts one of three or more different numeric values.

According to an embodiment, e.g., the control module 110 may include a multiplexer 115 and lines, e.g., wherein the multiplexer 115 may be configured to connect the lines. In this case, the control module 110 may be configured to apply the first input voltage, the second input voltage and the third input voltage to the switchable resistive element 120 (cf. FIG. 5 and FIG. 7) via the lines and via the multiplexer 115.

FIG. 2 shows a decoder 200 for decoding an input current of an input current signal by outputting an output binary value of a binary output data sequence according to an embodiment. The decoder 200 includes a control module 210, a switchable resistive element 220 and a comparator 230.

The switchable resistive element 220 (also referred to as complimentary resistive switch) is configured to either be in a first state or in a different second state depending on a first input voltage at a first point in time and depending on a second input voltage at a later second point in time.

The control module 210 is configured to apply the first input voltage to the switchable resistive element 220 at the first point in time so that the first input voltage depends on a sample binary value of a plurality of sample binary values.

In addition, the control module 210 is configured to apply the second input voltage to the switchable resistive element 220 at the second point in time so that the second input voltage depends on a pseudo-random binary value of a plurality of pseudo-random binary values of a first binary pseudo-random data sequence.

In addition, the control module 210 is configured to apply a third input voltage to the switchable resistive element 220 at a third point in time after the second point in time so that that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence.

The switchable resistive element 220 is configured, upon applying the third input voltage at the third point in time, to provide an output current to the comparator 230 so that said output current depends on the third input voltage and depends on whether the switchable resistive element 220 is in the first state or in the second state.

The comparator 230 is configured to perform a comparison between said output current and said input current, wherein the comparator 230 is configured to determine said output binary value depending on the comparison and on said sample binary value, and wherein the comparator 230 is configured to output said output binary value.

According to an embodiment, e.g., the comparator 230 may be configured to determine said sample binary value as said output binary value and output the same if a magnitude of a difference between the output current and the said input current is smaller than a limit. In this case, e.g., the comparator 230 may be configured to determine an inverted binary value of said sample binary value as said output binary value and output the same if a magnitude of a difference between the output current and said input current is larger than or equal to the limit.

According to an embodiment, e.g., the switchable resistive element 220 may be configured, upon applying the third input voltage at the third point in time, to provide said output current to the comparator 230 such that:
said output current comprises a first output current value if the third input voltage comprises a first input voltage value and the switchable resistive element 220 is in the first state,
said output current comprises a second output current value that is larger than the first output current value if the third input voltage comprises a second input voltage value and the switchable resistive element 220 is in the first state,
said output current comprises a third output current value if the third input voltage comprises the first input voltage value and the switchable resistive element 220 is in the second state, and
said output current comprises a fourth output current value that is smaller than the third output current value if the third input voltage comprises the second input voltage value and the switchable resistive element 220 is in the second state.

In this case, e.g., the first output current value and the fourth output current value may be equal or different, and, e.g., the second output current value and the third output current value may be equal or different.

In an embodiment, e.g., the switchable resistive element 220 may be a memristor.

According to an embodiment, e.g., the control module 210 may include a first pseudo-random generator 211, e.g., that may be configured to generate the first pseudo-random generator sequence. Or, e.g., the control module 210 may include the first pseudo-random generator 211, e.g., that may be configured to generate the first pseudo-random generator sequence, and, e.g., wherein the control module 210 may include a second pseudo-random generator 212, e.g., that may be configured to generate the second pseudo-random generator sequence (cf. FIG. 5 and FIG. 7).

In an embodiment, e.g., the control module 210 may be configured to link said input binary value to said pseudo-random binary value of the plurality of pseudo-random binary values of the second binary pseudo-random data sequence by means of a Boolean operation in order to obtain a combination binary value. In this case, e.g., the control module 210 may be configured to apply the first input voltage to the switchable resistive element 220 at the first point in time so that the first input voltage depends on the combination binary value. In addition, e.g., the control module 210 may be configured to apply the third input voltage to the switchable resistive element 220 at the third point in time so that the third input voltage depends on said pseudo-random binary value of the plurality of pseudo-random binary values of the second binary pseudo-random data sequence.

According to an embodiment, e.g., the Boolean operation may be a XOR operation or a XNOR operation.

In an embodiment, e.g., the control module 210 may be configured to apply the third input voltage to the switchable resistive element 220 at the third point in time so that the third input voltage does not depend on said input binary value.

According to an embodiment, e.g., the control module 210 may be configured to apply the first input voltage to the switchable resistive element 220 so that the first input voltage is either positive or negative depending on said input binary value. In this case, e.g., the control module 210 may be configured to apply the second input voltage to the switchable resistive element 220 so that the second input voltage is either positive or negative depending on said pseudo-random binary value of the plurality of pseudo-random binary values of the first binary pseudo-random data sequence. In addition, e.g., the control module 210 may be configured to apply the third input voltage to the switchable resistive element 220 so that the third input voltage is either positive or negative depending on said pseudo-random binary value of the plurality of pseudo-random binary values of the first binary pseudo-random data sequence or depending on said pseudo-random binary value of the plurality of pseudo-random binary values of the second binary pseudo-random data sequence.

In an embodiment, e.g., the control module 210 may be configured to determine an amplitude of the first input value and/or of the second input value depending on a pseudo-random value of a third pseudo-random data sequence.

According to an embodiment, e.g., the control module 210 may be configured to determine one of three or more different amplitude values for the amplitude of the first input voltage and/or of the second input voltage depending on said pseudo-random value of the third pseudo-random data sequence.

In an embodiment, e.g., the control module 210 may include a third pseudo-random generator 213, e.g., that may be configured to generate the third pseudo-random generator sequence so that each pseudo-random value of the third pseudo-random data sequence adopts one of three or more different numeric values.

According to an embodiment, e.g., the control module 210 may include a multiplexer 215 and lines, e.g., wherein the multiplexer 215 may be configured to connect the lines. In this case, the control module 210 may be configured to apply the first input voltage, the second input voltage and the third input voltage to the switchable resistive element 220 (cf. FIG. 5 and FIG. 7) via the lines and via the multiplexer 215.

FIG. 3 shows a system including an encoder 100 according to any one of the above-described embodiments for encoding an input binary value of a binary input data sequence by generating an output current of an output current signal, and a decoder 200 according to any one of the above-described embodiments for decoding an input current of an input current signal by outputting an output binary value of a binary output data sequence.

The decoder 200 is configured to use and decode the input current from the encoder 100.

In an embodiment, e.g., the first binary pseudo-random data sequence of the encoder 100 and the first binary pseudo-random data sequence of the decoder 200 may be equal. In this case, e.g., the second binary pseudo-random data sequence of the encoder 100 and the second binary pseudo-random data sequence of the decoder 200 may be equal. For example, the switchable resistive element 220 of the encoder 100 and the switchable resistive element 220 of the decoder 200 may be configured, at the same first input voltage and at the same second input voltage, to both either be in the first state or to both either be in the second state. In addition, e.g., the switchable resistive element 220 of the encoder 100 and the switchable resistive element 220 of the decoder 200 may be configured, upon applying the same third input voltage, to output or provide a same output current.

Embodiments describe a protocol for secure data transmission by means of memristor-based PUFs, wherein a random generator is used for data encryption and another random generator is used for data decryption.

With respect to memristors, reference is explicitly made to document [6], in particular to document [6], page 44, lines 17-30, page 49, line 20-page 50, line 26, and page 50, line 33-page 55, bottom.

This closes a previously existing security gap in data transmission. For example, the hardware described in [2] and [5] may be used in embodiments for encrypting binary data and for storing the encrypted data. According to the concepts described in embodiments, e.g., the hardware stores the encrypted data and therefore provides a direct protection against an attack since, according to the described concepts, the read-out mechanism cannot be predicted by an attacker. In order to read out the data, the attacker would have to know the random generator for data encryption and the random generator for data decryption. This complicates and/or prevents data decryption for an attacker.

In general, a memristor comprises a stochastic write mechanism and a deterministic read mechanism. According to the method, a memristor having two reconfigurable barriers is used for storing the data with a random generator for data encryption PRSG Boolean 112; 212 of the binary input data and a random sequence of binary numbers PRSG Boolean 111; 211 generated by means of a random generator by means of a randomly selected Boolean function. The sequence of the two write pulses C.HV1 and C.HV2 defines the non-volatile state pairs (LRSp, HRSn) and (LRSn, HRSp). The state pair last written and set in a non-volatile manner is readout with the randomly selected read pulse C.LV.

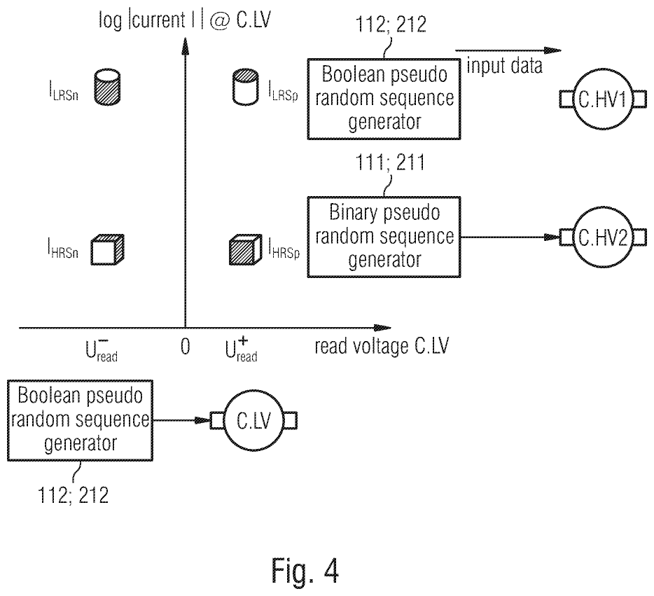

In an embodiment, e.g., the reading is performed in the “level read” scheme, not in the “spike read” scheme. Among other things, it is an advantage that the voltage range for HRS in particular does not have to be exactly adjusted as per mV (cf. FIG. 4).

Since encrypting is carried out in a non-volatile manner in the complimentary resistive switch M, the binary input data may be encrypted sequentially. Reading out the encrypted data is carried out with the random generator PRSG Boolean 112; 212 so that the same Boolean function is used for encrypting and for reading out.

This means that, by means of a memristor having two reconfigurable barriers M, the data is sequentially encrypted in a stochastic manner together with a stochastically selected binary numeric sequence and is also stochastically decrypted. The problem of stochastic decryption is solved by using an already known memristor whose resistance may be written in a non-volatile manner with two different polarities of the write voltage and whose resistance may be read out with two different polarities of the read voltage (FIG. 5).

According to the concept, a memristor having two reconfigurable barriers is used for storing the data with a random generator for data encryption PRSG Boolean 112; 212 of the binary input data and a random sequence of binary numbers PRSG Boolean 111; 211 generated by means of a random generator by means of the randomly selected Boolean function.

Optionally, security may be increased, e.g., by using a third random generator PRSG |V0| 113; 213 for encrypting the write amplitude so that binary input data is projected onto analog encrypted data. Through this ambiguous mapping, the security in the data encryption and in the data decryption may be further increased, for example.

The sequence of the two write pulses C.HV1 and C.HV2 defines the non-volatile state pairs (LRSp, HRSn), (LRSp′, HRSn′) and (LRSp″, HRSn″) such as (LRSn, HRSp), (LRSn′, HRSp′), and (LRSn″, HRSp″).

The amplitude V0 of the two write pulses C.HV1 and C.HV2 is randomly selected by means of the random generator PRSG |V0| 113; 213 and determines which one of the three non-volatile state pairs (LRSp, HRSn), (LRSp′, HRSn′) and (LRSp″, HRSn″) is written with the largest difference in the write current I. The larger the amplitude V0 of the write pulses, the larger the difference in the write current, i.e. the write currents with respect to the stage pairs (LRSp″, HRSn″) and (LRSn″, HRSp″). In the smallest amplitude V0 of the write pulses, the difference in the write current is the smallest, i.e. the write currents with respect to the state pairs (LRSp, HRSn) and (LRSn, HRSp). This opens up the possibility to encrypt binary input data as analog data.

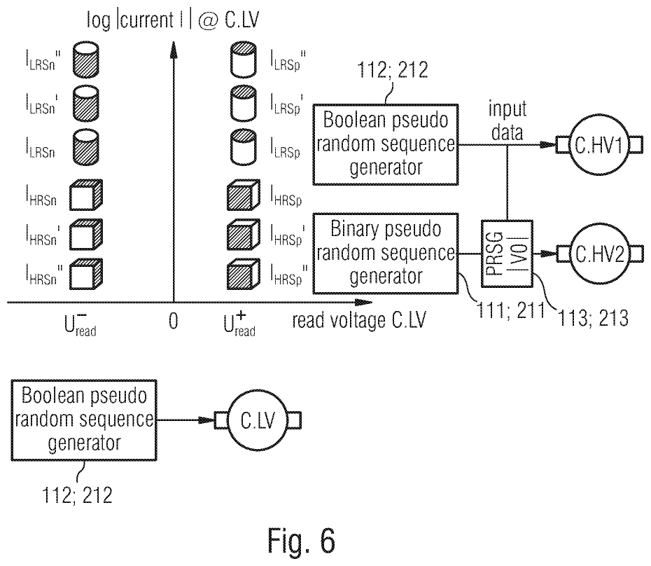

FIG. 6 illustrates how binary data is encrypted into three elements of analog data using three different amplitudes V0 according to an embodiment.

Same as for the complimentary resistive switch M with a fixed amplitude V0 of the write pulses (FIG. 4), the state pair last written and set in a non-volatile manner is read out with the randomly selected read pulse C.LV. In an embodiment, e.g., reading is performed in the “level read” scheme, not in the “spike read” scheme.

Since encrypting is carried out in a non-volatile manner in the complementary resistive switch M with a randomly selected amplitude V0 of the write pulses, the binary input data may be sequentially encrypted as analog data. Reading out the encrypted data carried out with the random generator PRSG Boolean 112; 212 so that the same Boolean function is used for encrypting and reading out.

This means that, by means of a memristor having two reconfigurable barriers M, the data is sequentially encrypted in a stochastic manner together with a stochastically selected binary numeric sequence and is also stochastically decrypted. The problem of stochastic decryption is solved by using an already known memristor whose resistance may be written in a non-volatile manner with two different polarities of the write voltage and whose resistance may be read out with two different polarities of the read voltage (FIG. 7).

FIG. 4 shows a write current I of a complimentary resistance (of a switchable resistive element 120; 220) according to an embodiment with a write pulse sequence C.HV1 and C.HV2 on a logarithmic scale at the write voltage C.LV. Depending on the polarity of the write voltage C.LV, at a positive polarity of the write voltage, the write current I_{LRSp} at the resistive state LRSp in the state pair (LRSp, HRSn) is read out and the write current I_{HRSp} at the resistive state HRSp in the state pair (LRSn, HRSp) is read out, and at a negative polarity of the write voltage, the write current I_{HRSn} at the resistive state HRSn in the state pair (LRSp, HRSn) is read out and the write current I_{LRSn} at the resistive state LRSn in the state pair (LRSn, HRSp) is read out.

FIG. 5 schematically shows a block circuit diagram for encryption and decryption of binary data using two random number generators PRSG Boolean 112; 212 and PRSG Boolean 111; 211 according to an embodiment.

FIG. 6 shows the write current I of a complimentary resistance into which three state pairs have been written by means of a write pulse sequence C.HV1 and C.HV2 with three different amplitudes V0 of the write pulses.

Depending on the polarity of the read voltage C.LV, at a positive polarity of the read voltage, the read current I_{LRSp}/I_{LRSp}′/I_{LRSp}″ at the resistive state LRSp/LRSp′/LRSp″ in the state pair (LRSp, HRSn)/(LRSp′, HRSn′)/(LRSp″, HRSn″) is read out and the read current I_{HRSp}/I_{HRSp}′/I_{HRSp}″ at the resistive state HRSp/HRSp′/HRSp″ in the state pair (LRSn, HRSp)/(LRSn′, HRSp′)/(LRSn″, HRSp″) is read out, and at a negative polarity of the read voltage, the read current I_{HRSn}/I_{HRSn}′/I_{HRSn}″ at the resistive state HRSn/HRSn′/HRSn″ in the state pair (LRSp, HRSn)/(LRSp′, HRSn′)/(LRSp″, HRSn″) is read out and the read current I_{LRSn}/I_{LRSn}′/I_{LRSn}″ at the resistive state LRSn/LRSn′/LRSn″ in the state pair (LRSn, HRSp)/(LRSn′, HRSp′)/(LRSn″, HRSp″) is read out.

FIG. 7 schematically shows a block circuit diagram for encryption and decryption of binary data using three random number generators PRSG Boolean 112; 212, PRSG Boolean 111; 211 and PRSG |V0| 113; 213 according to an embodiment.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer. The data carrier, the digital storage medium, or the recorded medium are typically tangible, or non-volatile.

A further embodiment of the inventive methods thus is a data carrier (or a digital storage medium or a computer-readable medium) on which the computer program for performing any of the methods described herein is recorded. The data carrier or the digital storage medium or the computer-readable medium are typically tangible and/or non-volatile.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device.

Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Cisco, The Zettabyte Era: Trends and Analysis, White Paper, (2014)

[2] U.S. Pat. No. 9,812,640 B2, Complementary resistance switch, contact-connected polycrystalline piezo- or ferroelectric thin film layer, method for encrypting a bit sequence, T. You, H. Schmidt, N. Du, D. Bürger, I. Skorupa, N. Manjunath, 2017

[3] Nan Du et al., J. Appl. Phys. 115, 124501 (2014).

[4] A. Ascoli, V. Senger, R. Tetzlaff, N. Du, O. G. Schmidt, and H. Schmidt, “BiFeO3 memristor-based encryption of medical data”, Int. Symp. Circ. and Syst. (ISCAS), 2016.

[5] T. You , Y. Shuai, W. Luo, N. Du, D. Bürger, I. Skorupa, R. Hübner, S. Henker, C. Mayr, R. Schüffny, T. Mikolajick, O. G. Schmidt, and H. Schmidt, Exploiting Memristive BiFeO3 Bilayer Structures for Compact Sequential Logics, Adv. Funct. Mater. 2014 , DOI: 10.1002/adfm.201303365.

[6] WO 2014/111481 A2, Complementary resistor switch, contact-connected polycrystalline piezo- or ferroelectric thin-film layer, method for encrypting a bit sequence, T. You, H. Schmidt, N. Du, D. Bürger, I. Skopura, Y. Shuai, 2014.

1. An encoder for encoding an input binary value of a binary input data sequence by generating an output current of an output current signal, the encoder comprising:
a control module; and
a switchable resistive element configured to either be in a first state or in a different second state depending on a first input voltage at a first point in time and depending on a second input voltage at a later second point in time,
wherein the control module is configured to apply the first input voltage to the switchable resistive element at the first point in time so that the first input voltage depends on said input binary value,
wherein the control module is configured to apply the second input voltage to the switchable resistive element at the second point in time so that the second input voltage depends on a pseudo-random binary value of a plurality of pseudo-random binary values of a first binary pseudo-random data sequence,
wherein the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence, and
wherein switchable resistive element is configured, upon applying the third input voltage at the third point in time, to output said output current so that said output current depends on the third input voltage and depends on whether the switchable resistive element is in the first state or in the second state.

2. The encoder according to claim 1,
wherein the switchable resistive element may be configured, upon applying the third input voltage at the third point in time, to output said output current,
so that said output current comprises a first output current value if the third input voltage comprises a first input voltage value and the switchable resistive element is in the first state,
so that said output current comprises a second output current value larger than the first output current value if the third input voltage comprises a second input voltage value and the switchable resistive element is in the first state,
so that said output current comprises a third output current value if the third input voltage comprises the first input voltage value and the switchable resistive element is in the second state, and
so that such that said output current comprises a fourth output current value smaller than the third output current value if the third input voltage comprises the second input voltage value and the switchable resistive element is in the second state,
wherein the first output current value and the fourth output current value are equal or different, and wherein the second output current value and the third output current value are equal or different.

3. The encoder according to claim 1,
wherein the switchable resistive element is a memristor.

4. The encoder according to claim 1,
wherein the control module comprises a first pseudo-random generator configured to generate the first pseudo-random generator sequence, or
wherein the control module comprises the first pseudo-random generator configured to generate the first pseudo-random generator sequence, and wherein the control module comprises a second pseudo-random generator configured to generate the second pseudo-random generator sequence.

5. The encoder according to claim 1,
wherein the control module is configured to link said input binary value to said pseudo-random binary value of the plurality of pseudo-random binary values of the second binary pseudo-random data sequence by means of a Boolean operation in order to acquire a combination binary value,
wherein the control module is configured to apply the first input voltage to the switchable resistive element at the first point in time so that the first input voltage depends on the combination binary value,
wherein the control module is configured to apply the third input voltage to the switchable resistive element at the third point in time so that the third input voltage depends on said pseudo-random binary value of the plurality of pseudo-random binary values of the second binary pseudo-random data sequence.

6. The encoder according to claim 5,
wherein the Boolean operation is a XOR operation or a XNOR operation.

7. The encoder according to claim 5,
wherein the control module is configured to apply the third input voltage to the switchable resistive element at the third point in time so that the third input voltage does not depend on said input binary value.

8. The encoder according to claim 1,
wherein the control module is configured to apply the first input voltage to the switchable resistive element so that the first input voltage is either positive or negative depending on said input binary value, and
wherein the control module is configured to apply the second input voltage to the switchable resistive element so that the second input voltage is either positive or negative depending on said pseudo-random binary value of the plurality of pseudo-random binary values of the first binary pseudo-random data sequence, and
wherein the control module is configured to apply the third input voltage to the switchable resistive element so that the third input voltage is either positive or negative depending on said pseudo-random binary value of the plurality of pseudo-random binary values of the first binary pseudo-random data sequence or depending on said pseudo-random binary value of the plurality of pseudo-random binary values of the second binary pseudo-random data sequence.

9. The encoder according to claim 8,
wherein the control module is configured to determine an amplitude of the first input voltage and/or of the second input voltage depending on a pseudo-random value of a third pseudo-random data sequence.

10. The encoder according to claim 9,
wherein the control module is configured to determine one of three or more different amplitude values for the amplitude of the first input voltage and/or of the second input voltage depending on said pseudo-random value of the third pseudo-random data sequence.

11. The encoder according to claim 10,
wherein the control module comprises a third pseudo-random generator configured to generate the third pseudo-random generator sequence so that each pseudo-random value of the third pseudo-random data sequence adopts one of three or more different numeric values.

12. The encoder according to claim 1,
wherein the control module comprises a multiplexer and lines, wherein the multiplexer is configured to connect the lines,
wherein the control module is configured to apply the first input voltage, the second input voltage and the third input voltage to the switchable resistive element via the lines and via the multiplexer.

13. A decoder for decoding an input current of an input current signal by outputting an output binary value of a binary output data sequence, the decoder comprising:
a control module,
a switchable resistive element configured to either be in a first state or in a different second state depending on a first input voltage at a first point in time and depending on a second input voltage at a later second point in time, and
a comparator,
wherein control module is configured to apply the first input voltage to the switchable resistive element at the first point in time so that the first input voltage depends on a sample binary value of a plurality of sample binary values,
the control module is configured to apply the second input voltage to the switchable resistive element at the second point in time so that the second input voltage depends on a pseudo-random binary value of a plurality of pseudo-random binary values of a first binary pseudo-random data sequence,
wherein the control module is configured to apply a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence, and
wherein the switchable resistive element is configured, upon applying the third input voltage at the third point in time, to provide an output current to the comparator so that said output current depends on the third input voltage and depends on whether the switchable resistive element is in the first state or in the second state,
wherein comparator is configured to perform a comparison between said output current and said input current, wherein the comparator is configured, depending on the comparison and said sample binary value, to determine said output binary value, and wherein the comparator is configured to output said output binary value.

14. The decoder according to claim 13,
wherein the comparator is configured to determine said sample binary value as said output binary value and output the same if a magnitude of a difference between the output current and the said input current is smaller than a limit,
wherein the comparator is configured to determine an inverted binary value of said sample binary value as said output binary value and output the same if a magnitude of a difference between the output current and said input current is larger than or equal to the limit.

15. The decoder according to claim 13,
wherein the switchable resistive element is configured, upon applying the third input voltage at the third point in time, to provide said output current to the comparator,
so that said output current comprises a first output current value if the third input voltage comprises a first input voltage value and the switchable resistive element is in the first state,
so that said output current comprises a second output current value that is larger than the first output current value if the third input voltage comprises a second input voltage value and the switchable resistive element is in the first state,
so that said output current comprises a third output current value if the third input voltage comprises the first input voltage value and the switchable resistive element is in the second state, and
so that said output current comprises a fourth output current value that is smaller than the third output current value if the third input voltage comprises the second input voltage value and the switchable resistive element is in the second state,
wherein the first output current value and the fourth output current value are equal or different, and wherein the second output current value and the third output current value are equal or different.

16. The decoder according to claim 13,
wherein the switchable resistive element is a memristor.

17. The decoder according to claim 13,
wherein the control module comprises a first pseudo-random generator configured to generate the first pseudo-random generator sequence, or
wherein the control module comprises the first pseudo-random generator configured to generate the first pseudo-random generator sequence, and wherein the control module comprises a second pseudo-random generator configured to generate the second pseudo-random generator sequence.

18. The decoder according to claim 13,
wherein the control module is configured to link said sample binary value to said pseudo-random binary value of the plurality of pseudo-random binary values of the second binary pseudo-random data sequence by means of a Boolean operation in order to acquire a combination binary value,
wherein the control module is configured to apply the first input voltage to the switchable resistive element at the first point in time so that the first input voltage depends on the combination binary value,
wherein the control module is configured to apply the third input voltage to the switchable resistive element at the third point in time so that the third input voltage depends on said pseudo-random binary value of the plurality of pseudo-random binary values of the second binary pseudo-random data sequence.

19. The decoder according to claim 18,
wherein the Boolean operation is a XOR operation or a XNOR operation.

20. The decoder according to claim 18,
wherein the control module is configured to apply the third input voltage to the switchable resistive element at the third point in time so that the third input voltage does not depend on said sample binary value.

21. The decoder according to claim 13,
wherein the control module is configured to apply the first input voltage to the switchable resistive element so that the first input voltage is either positive or negative depending on said input binary value,
wherein the control module is configured to apply the second input voltage to the switchable resistive element so that the second input voltage is either positive or negative depending on said pseudo-random binary value of the plurality of pseudo-random binary values of the first binary pseudo-random data sequence, and
wherein the control module is configured to apply the third input voltage to the switchable resistive element so that the third input voltage is either positive or negative depending on said pseudo-random binary value of the plurality of pseudo-random binary values of the first binary pseudo-random data sequence or depending on said pseudo-random binary value of the plurality of pseudo-random binary values of the second binary pseudo-random data sequence.

22. The decoder according to claim 21,
wherein the control module is configured to determine an amplitude of the first input voltage and/or of the second input voltage depending on a pseudo-random value of a third pseudo-random data sequence.

23. The decoder according to claim 22,
wherein the control module is configured to determine one of three or more different amplitude values for the amplitude of the first input voltage and/or of the second input voltage depending on said pseudo-random value of the third pseudo-random data sequence.

24. The decoder according to claim 23,
wherein the control module comprises a third pseudo-random generator configured to generate the third pseudo-random generator sequence so that each pseudo-random value of the third pseudo-random data sequence adopts one of three or more different numeric values.

25. The decoder according to claim 13,
wherein the control module comprises a multiplexer and lines, wherein the multiplexer is configured to connect the lines,
wherein the control module is configured to apply the first input voltage, the second input voltage and the third input voltage to the switchable resistive element via the lines and via the multiplexer.

26. The decoder according to claim 13,
wherein each sample binary value of the plurality of sample binary values comprises the same binary value.

27. A system, comprising:
an encoder according to claim 1 for encoding an input binary value of a binary input data sequence by generating an output current of an output current signal, and
a decoder according to claim 13 for decoding an input current of an input current signal by outputting an output binary value of a binary output data sequence,
wherein the decoder according to claim 13 is configured to use the output current generated by the encoder according to claim 1 as an input current and decode the same.

28. The system according to claim 27,
wherein the first binary pseudo-random data sequence of the encoder according to claim 1 and the first binary pseudo-random data sequence of the decoder according to claim 13 are the same,
wherein the second binary pseudo-random data sequence of the encoder according to claim 1 and the second binary pseudo-random data sequence of the decoder according to claim 13 are the same,
wherein the switchable resistive element of the encoder according to claim 1 and the switchable resistive element of the decoder according to claim 13 are configured, at the same first input voltage and at the same second input voltage, to both either be in the first state or to both either be in the second state, and
wherein the switchable resistive element of the encoder according to claim 1 and the switchable resistive element of the decoder according to claim 13 are configured, upon applying the same third input voltage, to provide or output a same output current.

29. A method for encoding an input binary value of a binary input data sequence by generating an output current of an output current signal, wherein a switchable resistive element is configured to either be in a first state or in a different second state depending on a first input voltage at a first point in time and depending on a second input voltage at a later second point in time, the method comprising:
applying the first input voltage to the switchable resistive element at the first point in time so that the first input voltage depends on said input binary value;
applying the second input voltage to the switchable resistive element at the second point in time so that the second input voltage depends on a pseudo-random binary value of a plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; and
upon applying the third input voltage at the third point in time, outputting said output current by the switchable resistive element so that said output current depends on the third input voltage and depends on whether the switchable resistive element is in the first state or in the second state.

30. A method for decoding an input current of an input current signal by outputting an output binary value of a binary output data sequence, wherein a switchable resistive element is configured to either be in a first state or in a different second state depending on a first input voltage at a first point in time and depending on a second input voltage at a later second point in time, the method comprising:
applying the first input voltage to the switchable resistive element at the first point in time so that the first input voltage depends on a sample binary value of a plurality of sample binary values;
applying the second input voltage to the switchable resistive element at the second point in time so that the second input voltage depends on a pseudo-random binary value of the plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence;
upon applying the third input voltage at the third point in time, providing an output current by the switchable resistive element so that said output current depends on the third input voltage and depends on whether the switchable resistive element is in the first state or in the second state, and
performing a comparison between said output current and said input current, determining said output binary value depending on the comparison and on said sample binary value, and outputting said output binary value.

31. A non-transitory digital storage medium having a computer program stored thereon to perform the method for encoding an input binary value of a binary input data sequence by generating an output current of an output current signal, wherein a switchable resistive element is configured to either be in a first state or in a different second state depending on a first input voltage at a first point in time and depending on a second input voltage at a later second point in time, the method comprising:
applying the first input voltage to the switchable resistive element at the first point in time so that the first input voltage depends on said input binary value;
applying the second input voltage to the switchable resistive element at the second point in time so that the second input voltage depends on a pseudo-random binary value of a plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence; and
upon applying the third input voltage at the third point in time, outputting said output current by the switchable resistive element so that said output current depends on the third input voltage and depends on whether the switchable resistive element is in the first state or in the second state,
when said computer program is run by a computer.

32. A non-transitory digital storage medium having a computer program stored thereon to perform the method for decoding an input current of an input current signal by outputting an output binary value of a binary output data sequence, wherein a switchable resistive element is configured to either be in a first state or in a different second state depending on a first input voltage at a first point in time and depending on a second input voltage at a later second point in time, the method comprising:
applying the first input voltage to the switchable resistive element at the first point in time so that the first input voltage depends on a sample binary value of a plurality of sample binary values;
applying the second input voltage to the switchable resistive element at the second point in time so that the second input voltage depends on a pseudo-random binary value of the plurality of pseudo-random binary values of a first binary pseudo-random data sequence;
applying a third input voltage to the switchable resistive element at a third point in time after the second point in time so that the third input voltage depends on said pseudo-random binary value of the plurality of pseudo-random binary values of the first binary pseudo-random data sequence or depends on a pseudo-random binary value of a plurality of pseudo-random binary values of a second binary pseudo-random data sequence;
upon applying the third input voltage at the third point in time, providing an output current by the switchable resistive element so that said output current depends on the third input voltage and depends on whether the switchable resistive element is in the first state or in the second state, and
performing a comparison between said output current and said input current, determining said output binary value depending on the comparison and on said sample binary value, and outputting said output binary value,
when said computer program is run by a computer.
